(19) United States
(12) Patent Application Publication
(10) Pub. No.: US 2014/0058887 A1
(43) Pub. Date: Feb. 27, 2014

(54) Systems and Methods for One-Click Registry

(71) Applicant: Brendan Kelly, Maplewood, NJ (US)

(72) Inventor: Brendan Kelly, Maplewood, NJ (US)

(73) Assignee: eBay Inc., San Jose, CA (US)

(21) Appl. No.: 13/592,232

(22) Filed: Aug. 22, 2012

(51) Int. Cl. G06Q 30/00

(52) U.S. Cl. 705/26.8

(57) ABSTRACT

Disclosed in some examples is a method, system and medium relating to a user selection of items for inclusion in a registry. An example method includes using at least one processor to present an interface to a user; displaying a plurality of items for sale on the interface; displaying on the interface, a registry selection element associated with each item of the plurality of items for sale, the registry selection element being selectable by a user to select the associated item for inclusion in a registry; and responsive to a user selection of a first registry selection element associated with a first item of the plurality of items for sale, recording, in a database, the first item as being included in the registry.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc., All Rights Reserved.

### BACKGROUND

Electronic interfaces such as web pages now include an abundance of information presented to a consumer such as detailed descriptions of products or services, related items, suggested items, customer reviews, recently viewed items, and the like. As the information presented to the consumer grows, it makes it more difficult to keep important information in front of the consumer because as the amount of information increases, the size of the page becomes larger. Consumers often need to navigate between pages or drill down to more data and may get “lost” in the amount of information. This may cause a lost sale as the consumer may forget what product they are interested in, or have difficulty finding the actionable items of a page in order to initiate a purchase. The actionable items may include items such as adding the product to a registry, such as a wish list registry, a baby registry, a wedding registry, or the like.

### EXAMPLES

Disclosed in some examples is a method including using at least one processor, presenting an interface to a user; displaying a plurality of items for sale on the interface; displaying on the interface, a registry selection element associated with each item of the plurality of items for sale, the registry selection element being selectable by a user to select the associated item for inclusion in a registry; and responsive to a user selection of a first registry selection element associated with a first item of the plurality of items for sale, recording, in a database, the first item as being included in the registry.

Disclosed in other examples is a system including at least one module, executing on one or more computer processors to: present an interface to a user; display a plurality of items for sale on the interface; display on the interface, a registry selection element associated with each item of the plurality of items for sale, the registry selection element being selectable by a user to select the associated item for inclusion in a registry; and responsive to a user selection of a first registry selection element associated with a first item of the plurality of items for sale, record in a database the first item as being included in the registry.

Disclosed in yet other examples is a machine readable medium, including instructions, which when performed by a machine, causes the machine to perform the operations of: presenting an interface to a user; displaying a plurality of items for sale on the interface; displaying on the interface, a registry selection element associated with each item of the plurality of items for sale, the registry selection element being selectable by a user to select the associated item for inclusion in a registry; and responsive to a user selection of a first registry selection element associated with a first item of the plurality of items for sale, recording, in a database, the first item as being included in the registry.

These examples can be combined in any permutation or combination. This overview is intended to provide an overview of subject matter of the present patent application. It is not intended to provide an exclusive or exhaustive explanation of the invention. The detailed description is included to provide further information about the present subject matter.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a screenshot showing an example interface according to an example embodiment of the present disclosure.

FIG. 2 is a flowchart of a method of presenting an information and action bar according to some examples of the present disclosure.

FIG. 3 is a schematic of a system of displaying an information and action bar according to some examples of the present disclosure.

FIG. 4 is a schematic of a machine according to some examples of the present disclosure.

### DETAILED DESCRIPTION

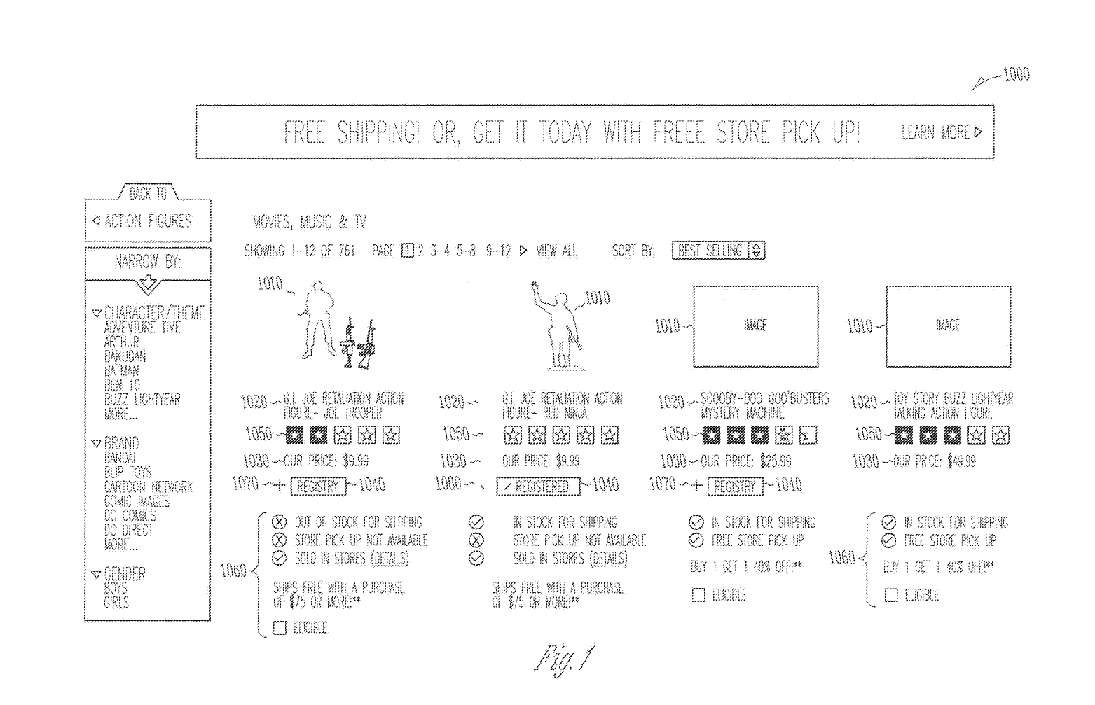

Turning now to FIG. 1, an example interface in the form of a web-page 1000 for selling a number of items for sale is shown. A description of each item, in this case a product, is shown to the user, which may include a graphical image of the product 1010, a title for the product 1020, a price 1030, a graphical summary of user reviews 1050, or the like. Further information about each product, such as the information indicated at 1060, may be displayed.

The interface also includes registry selection elements 1040. The registry selection elements 1040 may relate to an “add to cart” registry, a “baby” registry, a “wedding” registry, or an “add to wish list” registry, for example. Other registries are possible. The elements 1010, 1020, 1030, 1050, 1060, and the registry selection elements 1040 may each include graphical visual elements or indicia displayed in a user's internet browser, for example. In example embodiments, the elements 1010-1060 may be displayed in an interface such as a terminal or kiosk screen, or a screen of a portable electronic device such as a “smart phone”, for example. Other interfaces are possible.

A registry selection element 1040 may be associated with each of the plurality of products displayed for sale. Four products are displayed for sale on the interface shown in FIG. 1, but other numbers of products are possible. Three of the products displayed in the interface have a registry selection element 1040 associated with each of them. In the illustrated example, each registry selection element is displayed as a rectangular block, in which the word “Registry” appears. Other shapes and indicia are possible. Each registry selection element 1040 is selectable by a user, for example by a mouse “click” or finger touch on a touch-screen, to select the associated product for inclusion in a registry. In response to user selection of one or more of the selection elements, the associated product or products are recorded in a database as being included in the registry. A set of included registry items may then be viewed by a user as desired, either on the same interface, or another interface.

Each registry selection element may indicate a status associated with a successful inclusion of the associated product in the registry. For example, a “plus” sign displayed adjacent to or within the registry selection element 1040 may initially indicate that the associated product is available to be selected for inclusion in a registry. An example of such a display is shown in FIG. 1 at 1070. If a user wishes to include a given product in a registry, the associated registry selection element 1040 is selected. Once selected (e.g. by “clicking” on the element), a “slash” mark or “tick” sign may for example be displayed to indicate successful inclusion of the product in the registry. An example of such a display is shown in FIG. 1 at 1080. Other status indicators are possible, such as indicia, graphical images, or other indicators.

In an example embodiment, one of the registry selection elements 1040 associated with an item for sale is de-selectable by a user to remove that item from inclusion in the registry. In the illustrated embodiment, all the registry elements 1040 have this feature, but a fewer number of elements is possible. In an example embodiment, once a selected registry element 1040 indicates successful inclusion of the associated product in the registry, the element 1040 can be clicked again to remove that product from the registry. In this manner, the registry element 1040 can act like a “toggle” switch to allow user selection of an associated product to be included in, or removed from, the registry.

In an example embodiment, a registry selection element 1040 indicates a status associated with a successful removal of the associated item from the registry, in the illustrated example, such a status is indicated by a reversion of the “tick” sign to the “plus” sign, The status indication can thus include a change in appearance of the first registry selection element. Other changes in appearance, color, shape, or use of indicia are possible as status indictors.

In example embodiments, for example as illustrated in FIG. 1, a plurality of registry selection elements 1040 is displayed in a single, visible interface, with each selection element being associated with a respective displayed item for sale. The plurality of selection elements 1040 allows a user to select for recordal in a database at least one of the items for sale as being included in the registry. In example embodiments, user selection of one or more of the registry selection elements 1040 places the associated products in the recorded registry without requiring navigation by the user away from the single, visible interface. In an example embodiment, the registry is an on-line baby or wedding registry, but other registries are possible.

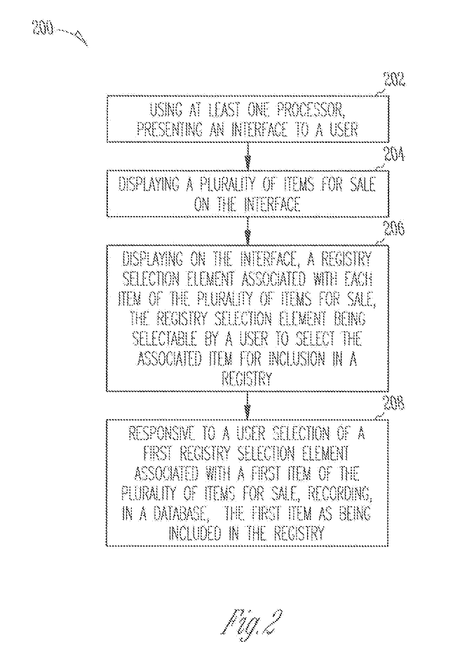

Turning now to FIG. 2, a method 200 is shown. The method 200 comprises: at 202, using at least one processor, presenting an interface to a user; at 204, displaying a plurality of items for sale on the interface; at 206, displaying on the interface, a registry selection element associated with each item of the plurality of items for sale, the registry selection element being selectable by a user to select the associated item for inclusion in a registry; and at 208 responsive to a user selection of a first registry selection element associated with a first item of the plurality of items for sale, recording, in a database, the first item as being included in the registry.

In example embodiments, the first registry selection element may indicate a status associated with a successful inclusion of the associated item in the registry. In example embodiments, the first registry selection element associated with a first item of the plurality of items for sale may be de-selectable by a user to remove the first item from inclusion in the registry. The first registry selection element may indicate a status associated with a successful removal of the associated item from the registry. The status indication may include a change in appearance of the first registry selection element once selected or de-selected, respectively.

In example embodiments, the method 200 further comprises displaying a plurality of registry selection elements in a single, visible interface, each selection element being associated with a respective displayed item for sale, the plurality of selection elements allowing a user to select for recordal, in a database, at least one of the items for sale as being included in the registry. In example embodiments, the method 200 further comprising receiving the user selection of the first registry selection element associated with the first item for sale, and including the first item in the registry without requiring navigation by the user away from the single, visible interface. The registry may be an on-line baby or wedding registry.

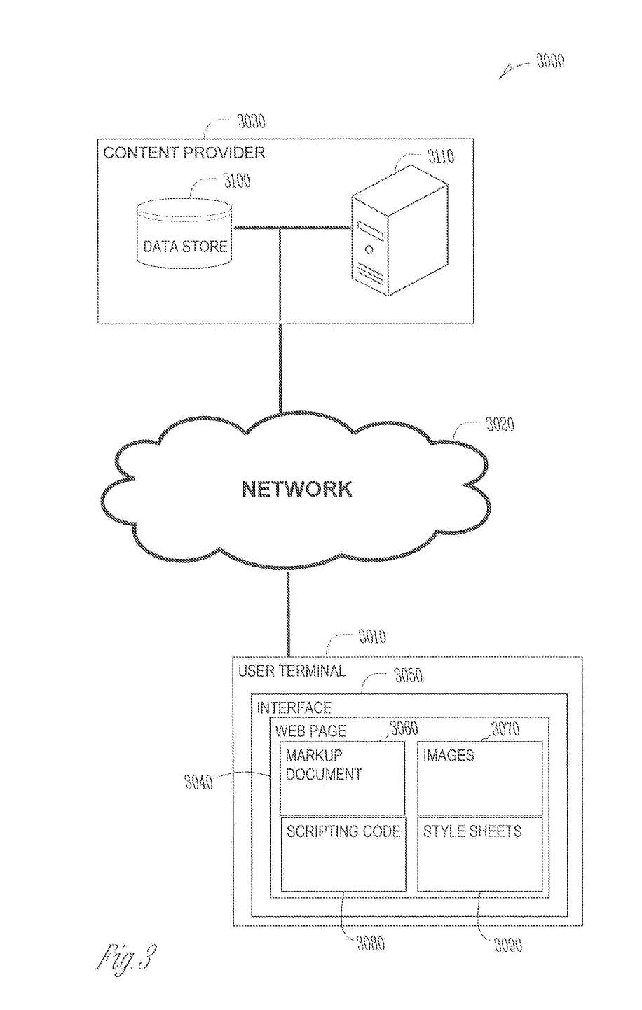

Turning now to FIG. 3, an example system 3000 is shown. User terminal 3010 may be used by a user to access interfaces such as web-pages across a network 3020. User terminal 3010 may be any user device capable of communicating with a content provider 3030 across a network 3020 and downloading and displaying interfaces 3040 in a browser 3050 (or other program). Example user terminals include desktop computers, server computers, tablet computers (e.g., an WAD manufactured by Apple Computer of Cupertino, Calif.), smartphones (e.g., smartphones running the DROID® operating system developed by GOOGLE, Inc., of Mountain View, Calif., or smartphones such as the iPhone®, manufactured by Apple Computer), cell phones, or other devices. Network 3020 may include any network which may connect user terminal 3010 and content provider 3030 and may include or be any portion of one or more of a Wide Area Network (WAN), Local Area Network (LAN), the Internet, a cellular network (e.g., a cellular network operating according to a Universal Mobile Telecommunications (UMTS) family of standards, or a Long Term Evolution (LTE) family of standards), or the like. Interface 3040 is interpreted and displayed by browser 3050 and may include one or more markup language documents 3060 including HyperText Markup Language (HTML), eXtensible Markup Language (XML), or the like. Interface page 3040 may also include one or more images 3070. Images 3070 may be digitally represented in any browser renderable format. Interface 3040 may also include one or more scripting modules 3080 for causing the browser 3050 to perform various actions. Scripting modules 3080 may be JavaScript modules, PHP modules, or the like. In some examples, scripting modules 3080 may include code which when executed by the user terminal 3010 may cause the information and action bar to display at the appropriate time. Interface 3040 may include one or more style sheets 3080, such as Cascading Style Sheets (CSS).

Content provider 3030 may include one or more data stores 3100 for storing content, such as web page 3040 for delivery to one or more user terminals 3010 upon request from user terminal 3010. Content provider 3030 may also include one or more servers 3110 for communicating with the user terminals 3010 over network 3020 and for causing content stored in the data store 3100 to be delivered to one or more user terminals 3010.

In some examples, the information and action bar may appear different to user's viewing the web-page on a mobile device. For example, the content provider 3030 may detect that user terminal 3010 is a mobile device such as a smartphone. In response to detecting that the user terminal 3010 is a smartphone, the content server may provide an alternative information and action bar through a different scripting module 3080. In other examples, the executable code which displays the information and action bar may detect that it is running on a mobile device. The mobile-enhanced information and action bar may be a simpler version with content tailored to a mobile device's more limited screen and user interface. For example, less information and/or less action elements may be displayed. The information and/or action elements may be displayed in a larger size (e.g., for better readability on a small display), a smaller size (e.g., to fit on a smaller display), a different color, a different font, a different font style, or the like.

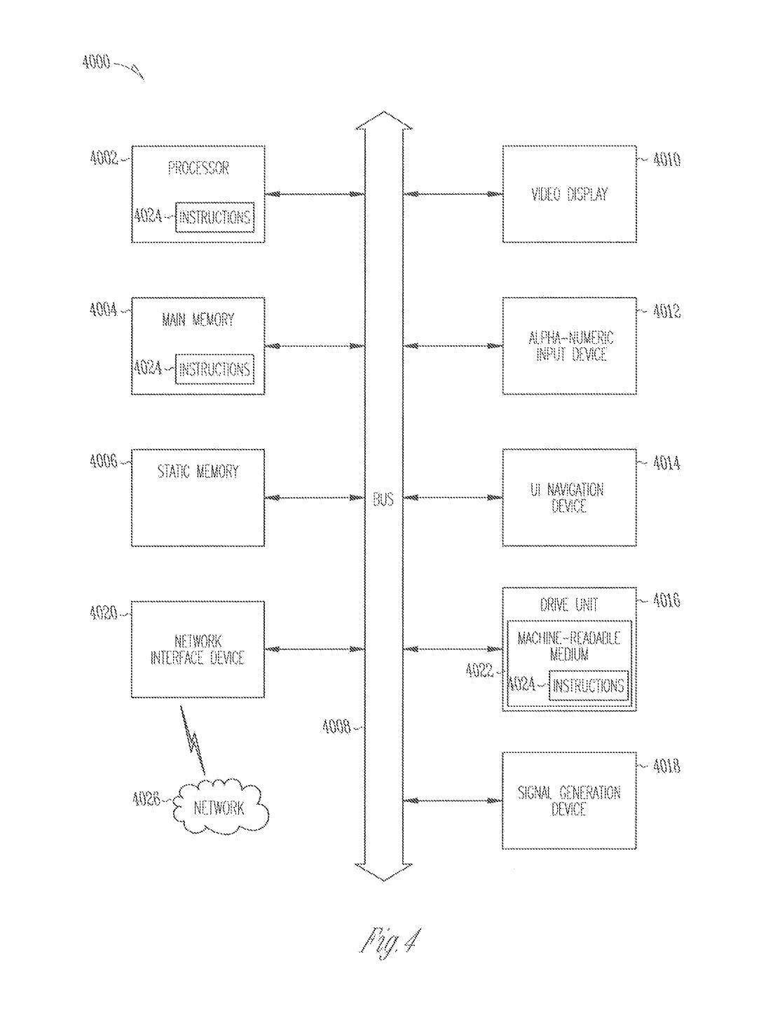

Turning now to FIG. 4, this view illustrates a block diagram of an example machine 4000 upon which any one or more of the techniques (e.g., methodologies) discussed herein can be performed. The user terminal and any components of the content provider 3030 may be or include one or more components of machine 4000. In various embodiments, the machine 4000 can operate as a standalone device or can be connected (e.g., networked) to other machines. In a networked deployment, the machine 4000 can operate in the capacity of a server machine, a client machine, or both in server-client network environments. In an example, the machine 4000 can act as a peer machine in peer-to-peer (P2P) (or other distributed) network environment. The machine 4000 can be a personal computer (PC), a tablet PC, a set-top box (STB), a Personal Digital Assistant (PDA), a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set or multiple sets) of instructions to perform any one or more of the methodologies discussed herein, such as cloud computing, software as a service (SaaS), other computer cluster configurations. For example, the functions of the machine 4000 can be distributed across multiple other machines in a network. Examples, as described herein, can include, or can operate on, logic or a number of components, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as one or more modules that can change over time. Software can accordingly configure a hardware processor, for example, to constitute a particular module at one instance of time and to constitute a different module at a different instance of time. Or to constitute one or more modules at the same time.

Machine (e.g., computer system) 4000 can include a hardware processor 4002 (e.g., a central processing unit (CPU), a graphics processing unit (GPU), a hardware processor core, or any combination thereof), a main memory 4004 and a static memory 4006, some or all of which can communicate with each other via a bus 4008. The machine 4000 can further include a display unit 4010, an alphanumeric input device 4012 (e.g., a keyboard), and a user interface (UI) navigation device 4011 (e.g., a mouse). In an example, the display unit 4010, input device 4017 and UI navigation device 4014 can be a touch screen display. The machine 4000 can additionally include a storage device (e.g., drive unit) 4016, a signal generation device 4018 (e.g., a speaker), a network interface device 4020, and one or more sensors 4021, such as a global positioning system (GPS) sensor, compass, accelerometer, or other sensor. The machine 4000 can include an output controller 4028, such as a serial (e.g., universal serial bus (USB), parallel, or other wired or wireless (e.g., infrared (IR)) connection to communicate or control one or more peripheral devices (e.g., a printer, card reader, etc.).

The storage device 4016 can include a machine-readable medium 4022 on which is stored one or more sets of data structures or instructions 4024 (e.g., software) embodying or utilized by any one or more of the techniques or functions described herein. The instructions 4024 can also reside, completely or at least partially, within the main memory 4004, within static memory 4006, or within the hardware processor 4002 during execution thereof by the machine 4000. In an example, one or any combination of the hardware processor 4002, the main memory 4004, the static memory 4006, or the storage device 4016 can constitute machine readable media.

While the machine-readable medium 4022 is illustrated as a single medium, the term “machine readable medium” can include a single medium or multiple media (e.g., a centralized or distributed database, and/or associated caches and servers) that configured to store the one or more instructions 4024.

The term “machine-readable medium” can include any tangible medium that is capable of storing, encoding, or carrying instructions for execution by the machine 4000 and that cause the machine 4000 to perform any one or more of the techniques of the present disclosure, or that is capable of storing, encoding or carrying data structures used by or associated with such instructions. Non-limiting machine-readable medium examples can include solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 4024 can further be transmitted or received over a communications network 4026 using a transmission medium via the network interface device 4020. Network interface device 4020 may connect the machine 4000 to a network of other machines in order to communicate with the other machines in the network by utilizing any one of a number of transfer protocols (e.g., frame relay, interact protocol (IP), transmission control protocol (TCP), user datagram. protocol (UDP), hypertext transfer protocol (HTTP), etc.). Example communication networks can include a local area network (LAN), a wide area network (WAN), a packet data network (e.g., the Internet), mobile telephone networks (e.g., cellular networks) such as a Long Term Evolution (LTE) network, Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 4020 can include one or more physical jacks (e.g., Ethernet, coaxial, or phone jacks) or one or more antennas to connect to the communications network 4026. In an example, and as shown in FIG. 4, the network interface device 4020 can include a plurality of antennas, to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 4000, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. A method comprising:
using at least one processor, presenting an interface to a user;
displaying a plurality of items for sale on the interface;
displaying on the interface, a registry selection element associated with each item of the plurality of items for sale, the registry selection element being selectable by a user to select the associated item for inclusion in a registry; and
responsive to a user selection of a first registry selection element associated with a first item of the plurality of items for sale, recording, in a database, the first item as being included in the registry.

2. The method of claim 1, wherein the first registry selection element indicates a status associated with a successful inclusion of the associated item in the registry.

3. The method of claim 1, wherein the first registry selection element associated with a first item of the plurality of items for sale is de-selectable by a user to remove the first item from inclusion in the registry.

4. The method of claim 3, wherein the first registry selection element indicates a status associated with a successful removal of the associated item from the registry.

5. The method of claim 2, wherein the status indication includes a change in appearance of the first registry selection element when selected or de-selected, respectively.

6. The method of claim 1, further comprising displaying a plurality of registry selection elements in a single, visible interface, each selection element being associated with a respective displayed item for sale, the plurality of selection elements allowing a user to select for recordal, in a database, at least one of the items for sale as being included in the registry.

7. The method of claim 6, further comprising receiving the user selection of the first registry selection element associated with the first item for sale, and including the first item in the registry without requiring navigation by the user away from the single, visible interface.

8. The method of claim 1, wherein the registry is an on-line baby or wedding registry.

9. A system comprising:
at least one module, executing on one or more computer processors, to:
present an interface to a user;
display a plurality of items for sale on the interface;
display on the interface, a registry selection element associated with each item of the plurality of items for sale, the registry selection element being selectable by a user to select the associated item for inclusion in a registry; and
responsive to a user selection of a first registry selection element associated with a first item of the plurality of items for sale, record in a database the first item as being included in the registry.

10. The system of claim 9, wherein the first registry selection element indicates a status associated with a successful inclusion of the associated item in the registry.

11. The system of claim 9, wherein the first registry selection element associated with a first item of the plurality of items for sale is de-selectable by a user to remove the first item from inclusion in the registry.

12. The system of claim 11, wherein the first registry selection element indicates a status associated with a successful removal of the associated item from the registry.

13. The system of claim 10, wherein the status indication includes a change in appearance of the first registry selection element when selected or de-selected, respectively.

14. The system of claim 9, wherein the at least one module is further to display a plurality of registry selection elements in a single, visible interface, each selection element being associated with a respective displayed item for sale, the plurality of selection elements allowing a user to select for recordal, in a database, at least one of the items for sale as being included in the registry.

15. The system of claim 14, wherein the at least one module is further to receive the user selection of the first registry selection element associated with the first item for sale, and include the first item in the registry without requiring navigation by the user away from the single, visible interface.

16. The system of claim 9, wherein the registry is an on-line baby or wedding registry.

17. A machine readable medium, including instructions, which when performed by a machine, causes the machine to perform the operations of:
presenting an interface to a user;
displaying a plurality of items for sale on the interface;
displaying on the interface, a registry selection element associated with each item of the plurality of items for sale, the registry selection element being selectable by a user to select the associated item for inclusion in a registry; and
responsive to a user selection of a first registry selection element associated with a first item of the plurality of items for sale, recording, in a database, the first item as being included in the registry.

18. The medium of claim 17, wherein the first registry selection element indicates a status associated with a successful inclusion of the associated item in the registry.

19. The medium of claim 17, wherein the first registry selection element associated with a first item of the plurality of items for sale is de-selectable by a user to remove the first item from inclusion in the registry.

20. The medium of claim 19, wherein the first registry selection element indicates a status associated with a successful removal of the associated item from the registry.

21. The medium of claim 18 or claim 20, wherein the status indication includes a change in appearance of the first registry selection element when selected or de-selected, respectively.

22. The medium of claim 17, further comprising displaying a plurality of registry selection elements in a single, visible interface, each selection element being associated with a respective displayed item for sale, the plurality of selection elements allowing a user to select for recordal, in a database, at least one of the items for sale as being included in the registry.

23. The medium of claim 17, wherein the operations further comprise receiving the user selection of the first registry selection element associated with the first item for sale, and including the first item in the registry without requiring navigation by the user away from the single, visible interface.

24. The medium of claim 17, wherein the registry is an on-line baby or wedding registry.
